(19) United States
(12) Patent Application Publication
(10) Pub. No.: US 2017/0221374 A1
(43) Pub. Date: Aug. 3, 2017

(54) Method for Analyzing Typological Polarities in the Personality

(71) Applicant: John van der Steur, Austin, TX (US)

(72) Inventor: John van der Steur, Austin, TX (US)

(21) Appl. No.: 15/421,360

(22) Filed: Jan. 31, 2017

Related U.S. Application Data
(60) Provisional application No. 62/289,292, filed on Jan. 31, 2016.

(51) Int. Cl. G09B 7/06; G06F 17/24

(52) U.S. Cl. CPC G09B 7/06; G06F 17/248

(57) ABSTRACT

The present disclosure relates to method and system of analyzing the typological polarities in the personality of individuals, which provides for individuals a way to discover their “true type”. In order to carry out this method the following core steps are followed: identify preference for functions, attitudes, temperaments, types, and sub types. Ultimately, at the conclusion of these steps the individual will get feedback from the system in the form of a personality profile which the individual can reflect on. If the data that identifies preference for functions and attitude shows a large statistical variance, the individual is invited to re-submit preference data until a satisfactory result is achieved for the user.

### CROSS REFERENCE TO RELATED APPLICATIONS

This application claims the priority of previously filed U.S. Provisional 62/289,292 filed Jan. 31, 2016.

### FIELD

This disclosure relates generally to methods and systems for analyzing personality type

### BACKGROUND

Personality type theories have been developed for centuries. For example, Hippocrates in ancient Greece identified the Four Humors. Other well-known psychologists and theorists including, but not limited to, Paracelsus, and the more contemporary Carl Jung, Isabel Myers-Briggs, Marston, Wilson, Alessandra, Merrill, and many others. Analysis of personality types is useful in facilitating better communications, human relationships, and appreciation of unique personal talents and qualities. Such analysis and identification is also useful to create effective collaboration in teams, groups, families, and organizations. It facilitates finding purpose and individual roles for individuals participating in any kind of group functioning the idea being that you find a role that fits your personality. Before the members of a team can become an integrated whole, they need to explore their personality differences and recognize the value of their sometimes opposing opinions. The ability to explore a problem from various angles is an essential awareness. For this purpose many kinds of methods, systems and personality tests have been developed. These solutions however have considerable flaws and fail to meet the needs of the industry because they have a low test-retest reliability, or they place individuals in mutually exclusive categories or they claim to predict things like behavior or job success for which there appears to be no proof. One of the most important areas where these solutions fail to meet industry needs is that of “true type”. If one's personality is the result of one's nature and nurture, it is possible that the nurture component of one's personality has falsified one's natural type and that the type as it appears in one of these instruments is not one's innate or “true type” at all. The falsification of type leads to stress and a drain of energy as an individual takes on roles that do not fit its more innate or “true” type at all. Or as Carl Jung formulated: “as a rule, whenever such a falsification of type takes place as a result of external influence, the individual becomes neurotic later . . . . A reversal of type often proves exceedingly harmful to the physiological well-being of the organism, often provoking an acute state of exhaustion” (1923, p. 415). Other solutions attempt to claim statistical validity and reliability in determining one's personality type, but these solutions are unable to meet the needs of the industry because with their questionnaires the subject is inputting data about the subject self and this data is therefore subjective and not objective by definition. Therefore it is a claim that cannot be methodologically claimed. Still other solutions claim to be based on carl Jung's theoretical model, but these solutions are unable to meet the needs of the industry because only represent a subset of Carl Jung's theory of the personality and miss essential elements. Still other solutions claim to be based on Carl Jung's theoretical model, but these solutions are unable to meet the needs of the industry because they are based on translation errors in in translation Jungs book “Psychological Types” from German to English.

It would be desirable to have a method and system that analyzes an individual's personality and helps an individual determine what their “true type” is. Furthermore, it would also be desirable to have a system that can explain why test and re-test scores are different and treat those scores as mileposts in and individuals self awareness. Still further, it would be desirable to have a system that does not categorize or “box” people in a flat number of types (4, 5, 8, or 16) but distinguished levels of typological differentiation. Still further, it would be desirable to have a system that not only is a reflection of the original principles of psychological types as conceived by Carl Jung, but also updates them based on more than nine decades of experience with his work. Therefore, there currently exists a need in the industry for a system that reclassifies Carl Jung's typological system using a holistic approach and a system of gathering data from an individual and formatting it in such a way that upon reflection an individual can quickly and effectively determine their “true type” in relatively few iterations.

### SUMMARY

The aforementioned needs can be met by a method for analyzing personality type for an individual including at least: presenting the individual with a plurality of questions and requesting the individual to select one of multiple responses to each question; feeding the responses into a software based preference calculator; using the preference calculator to calculate mean and standard deviations for each of the four functions sensing, intuition, thinking, and feeling; using the preference calculator to calculate mean and standard deviations for each of the two attitudes introversion and extroversion; using the preference calculator to calculate mean and standard deviations for each of the four temperaments Inventor, Visionary, Helper, and Technician; using the preference calculator to calculate mean and standard deviations for each of the eight types Operator, Investigator, Innovator, Architect, Caregiver, Host, Inspirer, and Visionary; using the preference calculator to calculate the mean and standard deviation of the differences between function pairs to determine the dominant function and the subtype; using the results from the preference calculator calculations to rank the functions, attitudes, temperaments, and subtypes; inserting the rankings results and images associated with those results into pre-prepared template documents; assembling these template documents into a comprehensive personality profile to present to the individual; wherein the individual can then reflect upon their profile and decide if it is a good fit, or decide to re-take the questionnaire n times during any period of time until a good fit is experienced.

The method can also be met wherein the step of assembling template documents into a comprehensive personality profile further comprises utilizing a pre-prepared introduction template document and a prepared self-reflection document added to the personality profile.

The needs can also be met by a computing system for analyzing personality types for an individual including at least: a first computer readable code for presenting the individual with a plurality of questions and requesting the individual to select one of multiple responses to each question; a second computer readable code for feeding the responses into a software based preference calculator that acts on the responses to calculate the mean and standard deviations for each of four functions sensing, intuition, thinking, and feeling; for each of two attitudes introversion and extroversion; for each of four temperaments Inventor, Visionary, Helper, and Technician, for each of eight types Operator, Investigator, Innovator, Architect, Caregiver, Host, Inspirer, and Visionary; and further to calculate the mean and standard deviation of the difference between function pairs T-F and S-N to determine the dominant function and the subtype; a third computer readable code for using the data from the preference calculator to rank all of the functions, attitudes, temperaments, types, and subtypes; a fourth computer readable code for inserting rankings results and images associated with those results into pre-prepared template documents, and then assembling these template documents into a comprehensive personality profile to present to the individual.

### BRIEF DESCRIPTION OF THE DRAWINGS

FIG. 1A is a Side view of a Typological Octahedron

FIG. 1B is a side view of a Typological Rhombicuboctahedron

FIG. 2 is a Top view of two dimensional personality grid

FIG. 3 is Triangles of all the Eight types

FIG. 4 is a flow chart of the methodology.

### DETAILED DESCRIPTION OF THE DISCLOSURE

The present disclosure advantageously fills the aforementioned deficiencies by providing a method and system for analyzing the personality which provides a solid theoretical foundation in the work of Carl Jung and a practical application of this work in helping individuals determine their true type and applying this knowledge in their lives.

The present disclosure is a system together with an associated computer process that implements a method for analyzing personality type. The system is made up of the following components: one or more questionnaires, a preference calculator, output template documents, graphic images and a profile generation process. These components are related as follows. The data from the questionnaire is processed in a preference calculator that determines the likely preference for one or more types. The calculations in the preference calculator are then used by the profile generation process to generate an individual's personality profile. The methodology for generating an individual's personality profile is described in detail in later paragraphs. The individual can then reflect upon their profile and decide it is a good fit, or decide to re-take the questionnaire n times during any period of time until a good fit is experienced. It is only through enhanced self-awareness that an individual can find a good fit. Each of those components are discussed below.

There is already extensive literature on standard questions in questionnaires that are effective in measuring the basic personality functions (thinking, feeling, sensing, and intuition. The approach described herein goes beyond that to distinguish different levels of the personality: functions (4), attitudes (2), temperaments (4), types (8) and subtypes (16).

Carl Jung's four functions are color coded for computer display or color printers as follows: Thinking (Blue), Feeling (Red), Sensing (Green), Intuition (Yellow). See for a description of the four functions Jung's book “Psychological Types”, 1923). These color codes also apply to the introverted or extraverted attitude of the four functions. In implementation of this on a computer monitor or printer our four combination or temperaments are also color coded. The Technician (Teal), the Inventor (Turquoise), the Visionary (Orange), the Helper (Terracotta).

The present disclosure may also have one or more of the following components. For the personality questionnaire there are several variations possible. One can measure functions separately, one can measure functions in pairs, one can measure function-attitudes. What is also possible is that if an individuals scores are clear in area A, but not in area B, that the questionnaire can continue with a subset of questions specifically aimed at area B in order to establish clarity there. The graphic elements can be reproduced in a physical shape (either 2D or 3D) and be used as extra tools to use to better understand someone's personality (either individually or in a group). And if an individual chooses to fill in the questionnaires over a certain time period an overview can be given of the results and of the statistical variances over time (e.g. through bell curves). Types can also be related to certain archtypes as defined by Carl Jung and others. Specific preference calculator functionality can be developed to make visual the relationship aspects between two people's personality and represented graphically. Specific preference calculator functionality can be developed to visualize the relationship between the conscious, sub-conscious and unconscious aspects of the personality and represented graphically. In addition to this specific applications of the profiling system can be made geared towards: relationships, teams, specific professions (e.g. lawyers, accountants, politicians, teachers, musicians), sports, cultural assessments of organizations, companies, countries, continents.

The present disclosure system is unique when compared with other known systems and solutions in that it provides:
a) A truly holistic approach of the personality. A person is shown areas of stronger preference and consciousness versus areas with more limited consciousness. However, all are there (also in the profile)!
b) Instead of trying to tell someone what their personality is, this disclosure gives you a method and a system to reflect on it yourself. This is important given the principle that self awareness leads to change.
c) Assumption relating to translation errors from German to English in Jung's work are corrected
d) All aspects of Carl Jung's personality system are represented, not just a subset
e) Feedback on the personality of an individual is presented in different levels: function pairs (4), function-attitude triads (8 types), function-attitude triads with dominant/inferior function (16 subtypes)
f) Questionnaires where individuals are able to rank sets of items in at least three different ways and if needed can focus on areas of unclarity to gain consciousness about one's “true type”.
g) Individuals do not get a one time test or assessment, they get a method, system and process that helps them discover it for themselves

The present disclosure now will be described more fully hereinafter with reference to the accompanying drawings, which are intended to be read in conjunction with both this summary, the detailed description and any preferred and/or particular embodiments specifically discussed or otherwise disclosed. This disclosure may, however, be embodied in many different forms and should not be construed as limited to the embodiments set forth herein; rather, these embodiments are provided by way of illustration only and so that this disclosure will be thorough, complete and will fully convey the full scope of the disclosure to those skilled in the art.

The present disclosure is directed to a method for analyzing the personality.

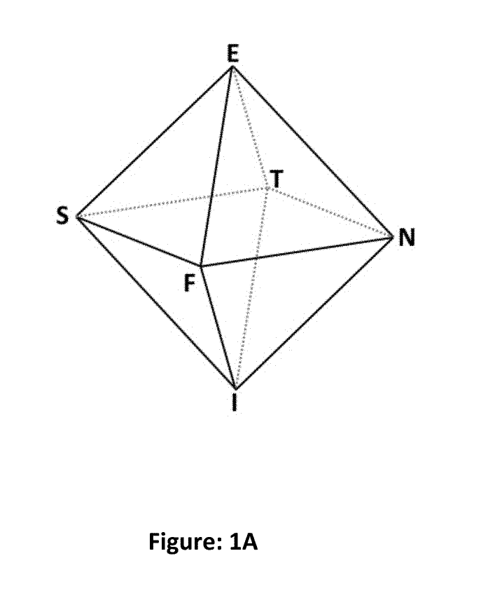

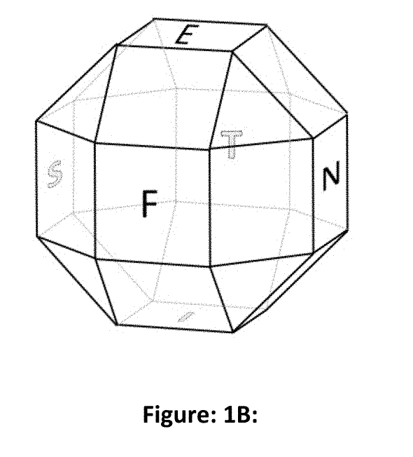

Turning to FIG. 1A. Jung used the octahedron (or: double quaternio, or double pyramid) as a symbol for the Self, as a model for the psyche. The geometrical shape of the octahedron is here applied to model Jung's typological theory. The four entrances to the personality are T, F, S and N (Thinking, Feeling, Sensing and Intuition), represented in FIG. 1 as the horizontal plane (SNTF). Everyone has these four entrances, openings or doors in the personality, but the order in which they prefer to use them is different. To determine someone's type it is important to find out which entrance they like to use the most. Then which one they like to use 2nd, 3rd and 4th. Therefore Jung's convention for the order of preference of the four functions is applied in this system.
1. Dominant function (used and relied upon most)
2. Auxiliary function (used and relied upon next)
3. Tertiary function (used occasionally)
4. Inferior function (used more selectively and with little or even no conscious control)

The horizontal plane (SNTF) in FIG. 1A represents the four core functions and fundamental building blocks of the personality. They are the deep underlying typological patterns from which people observe and act. It shows up in patterns of (inter)action, talents, needs, values, roles people play. The tips of the two pyramids represent the two attitudes introversion (I) and extraversion (E).

We also present herein FIG. 1B, an alternative symbolism using a Rhombicuboctahedron to represent the four core functions (SNTF) and the two attitudes (EI).

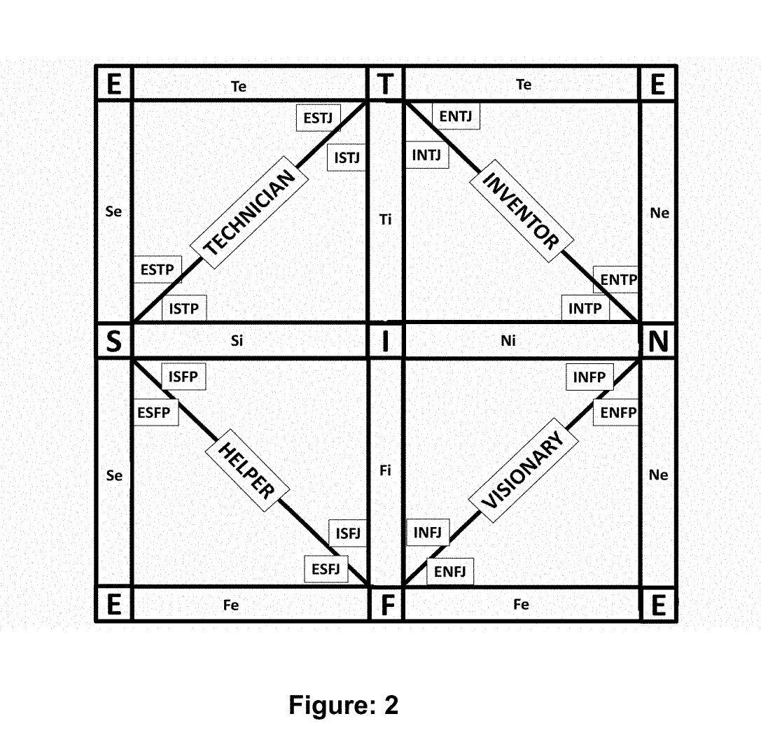

Turning now to FIG. 2, we can display the four temperaments that are derived from the methodology. FIG. 2 is a top view of the octahedron of FIG. 1A in which the four functions (SNTF) are seen as the rectangle SNTF and the attitude E is shown on the four corners and the attitude I is in the center. A visual analysis of the connections between functions reveals the four temperaments such as ST (Technician), NT (Inventor), NF (Visionary), and SF (Helper).

In addition FIG. 2 illustrates and displays the 16 Jungian sub-types INTJ, INFJ, to INTP, ISTP, ISTJ, ISFJ, INFP, ISFP, ENTP, ENFP, ENTJ, ESTJ, ESTP, ESFP, ENFJ, and ESFJ, showing their connections, and also shows the connections between the attitudes I (introversion) and E (extraversion) on the one hand and the four functions (SNTF) on the other hand. These connections are the lines (or Typological Meridians™) of the octahedron of FIG. 1.

Every individual will have lower or higher temperament scores based on the results of the questionnaires and their scoring from the Preference Calculator. A description of the four temperaments is given here:

### SF: Helper or Terracotta Temperament

This temperament sticks to the way things are and have always been. They are conscientious, follow the rules, respect and protect the rights of others and want their rights to be respected and protected. They take good care of theirs and other people's possessions. Loyalty to a thing or person.

### NF: Visionary or Orange Temperament

This temperament believes in dreams that are for the betterment of mankind and nourishes and develops these dreams. There is a desire to connect with others in harmony and create change for mankind. They strive for harmony and togetherness, believing we are all connected, no matter what our differences. Loyalty to a cause or purpose.

### ST: Technician or Teal Temperament

This temperament is skilled in working with practical, tangible things to make and create new things that are logical and mechanical in nature, based on cause and effect. They are focused on efficiency and do whatever works, whatever pays off, whatever is the shortest way to the goal, regardless of rules and regulations.

### NT: Inventor or Turquoise Temperament

This temperament likes to investigate new problems, great intriguing ideas, and develop them by applying logic to them. They strive for effectiveness (big steps, not small ones) and ignore the status quo.

### The Typological Trinity

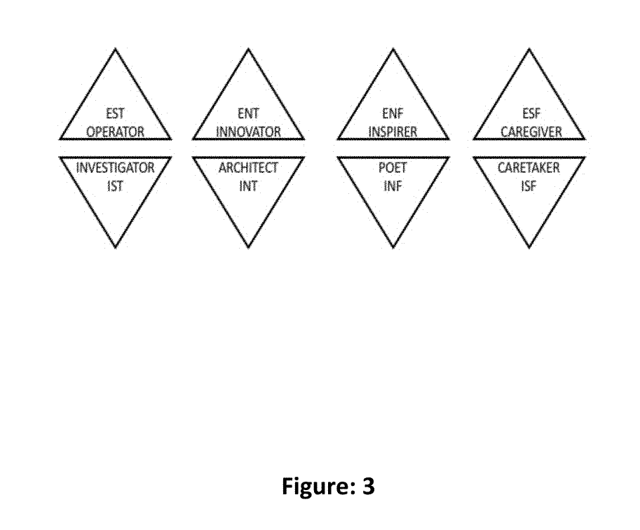

From four temperaments we derive the eight types as typological trinities; these are the triangular sides of the octahedron of FIG. 1 and are individually depicted in FIG. 3. The connections between the attitudes I (introversion) and E (extraversion) on the one hand and the four functions (SNTF) on the other hand, are the lines (or Typological Meridians™) of the octahedron.

These lines (or meridians) form the introverted and extraverted expression of the function.
Te=Extravert Thinking
Fe=Extravert Feeling
Se=Extravert Sensing
Ne—Extravert Intuition
Ti=Introvert Thinking
Fi=Introvert Feeling
Si=Introvert Sensing
Ni=Introvert Intuition

The Trinity in Type is formed by:
1. Attitude (I-E)
2. Perceiving function (S-N)
3. Judging function (T-F)

Each type is represented visually by a triangle. The triangles pointed up are the extraverted types, the triangles pointing down the introverted types. There are eight types in total: EST, IST, ESF, ISF, ENT, INT, INF, ENF. They are described by:

| | |
|---|---|
| Operator | EST |
| Investigator | IST |
| Innovator | ENT |
| Architect | INT |
| Caregiver | ESF |
| Caretaker | ISF |
| Inspirer | ENF |
| Poet | INF |

### The 16 Subtypes

The eight types above can further be split into 16 subtypes (INTJ, INFJ, INTP, ISTP, ISTJ, ISFJ, INFP, ISFP, ENTP, ENFP, ENTJ, ESTJ, ESTP, ESFP, ENFJ, and ESFJ) based on the dominance of the judging functions (T and F) versus the perceiving functions (S and N). For example, the type Poet above is described by the triad INF. It has two subtypes: INFP or INFJ. The P in this case means that the perceiving function N is dominant and F is the first auxiliary function and T is the tertiary function (S is the inferior function). The J means the judging function F is dominant and N is auxiliary, S tertiary an T the inferior function. Their place in the system can be viewed in FIG. 2.

Based on the framework above a personality type can be analyzed as follows.

In a first step a questionnaire is developed that will help build a questionnaire that can act as a tool for someone to assess his or her own personality. By carrying out the described methodology we can determine items (words or phrases) that reflect the different dimensions of the octahedron. We end up with a questionnaire that includes the items listed below in the table below that have items 1 . . . n for each of the categories

Let us assume we have found them and we have a collection as in the table below with items 1 . . . n for each of the categories relevant elements of the octahedron.

| Element | Items |
|---|---|
| Sensing (S) | S (1 . . . n) |
| Intuition (N) | N (1 . . . n) |
| Thinking (T) | T (1 . . . n) |
| Feeling (F) | F (1 . . . n) |
| Introversion | I (1 . . . n) |
| Extraversion | E (1 . . . n) |
| Introverted Sensing | Si (1 . . . n) |
| Extraverted Sensing | Se (1 . . . n) |
| Introverted Intution | Ni (1 . . . n) |
| Extraverted Intuition | Ne (1 . . . n) |
| Introverted Thinking | Ti (1 . . . n) |
| Extraverted Thinking | Te (1 . . . n) |
| Introverted Feeling | Ti (1 . . . n) |
| Extraverted Feeling | Fe (1 . . . n) |
| ST | ST (1 . . . n) |
| NT | NT (1 . . . n) |
| SF | SF (1 . . . n) |
| NF | NF (1 . . . n) |

For all options below a seven-level Likert scale where subject is asked to rank the different items is best used. Seven levels is the maximum. In some instances less levels maybe better better.

After ranking the items they are averaged and the standard deviation is calculated. We use the following definition for these.

Average: for example A(S) for the average score on S.

Standard Deviation: for example SD(S) for the standard deviation on S.

After the scores are calculated they are normalized on a percentage scale of 0 . . . 100% to be presented in the individual's profile.

A first embodiment is a questionnaire that consists of two parts.

Part one asks subject to rank S, N, T, F as follows:

| Question | 1 | . . . | n |
|---|---|---|---|
| S | S(1) | S( . . . ) | S(n) |
| N | N(1) | N( . . . ) | N(n) |
| T | T(1) | T( . . . ) | T(n) |
| F | F(1) | F( . . . ) | F(n) |

Part two asks the subject to rank I and E as follows:

| Question | 1 | . . . | n |
|---|---|---|---|
| I | I(1) | I( . . . ) | I(n) |
| E | E(1) | E( . . . ) | E(n) |

The average scores for the elements that are missing in this questionnaire are then calculated as follows:

A(Si)=(A(S)+A(I))/2

A(Ni)=(A(N)+A(I))/2

A(Ti)=(A(T)+A(I))/2

A(Fi)=(A(F)+A(I))/2

A(Se)=(A(S)+A(E))/2

A(Ne)=(A(N)+A(E))/2

A(Te)=(A(T)+A(E))/2

A(Fe)=(A(F)+A(E))/2

A(ST)=(A(S)+A(T))/2

A(NT)=(A(N)+A(T))/2

A(SF)=(A(S)+A(F))/2

A(NF)=(A(N)+A(F))/2

The exact same approach is used for the standard deviation.

After this the scores and rankings for the eight types or typological triangles are calculated. For example: A(INF)=A((NF)+A(I))/2; then it is necessary to determine the dominant function and subtype for the individual.

To determine the dominant and inferior function we look not at relative scores, but at the absolute difference between typological opposites:
A(S) and A(N)
A(T) and A(F)

The preference calculator is now used to calculate the mean and SD of the difference between function pairs to determine the dominant function and the subtype. The function pairs are T-F and S-N. The polarities with the greatest absolute difference constitute the dominant and inferior function pair. So for example, if S is not the highest score, but the difference between S and N is, then S is dominant (if S>N).

The preference calculator looks at the mean and the SD of the difference between the scores for these functions. In the function pair that has the biggest difference, the function that has the highest score is determined to be the dominant function of all four functions. Once the dominant function pair is known the subtype of the individual is established.

There are other possible ways for creating a questionnaire is to use the items in the table above for SF, ST, NF and NT to score the preference for temperaments and use mathematical equations like the ones above to determine the scores for the other elements of the personality. Or, instead of using statements for SF, ST, NF and NT, use the item “S1 and F1” for SF1, “S1 and T1” for ST1, “N1 and T1” for NT1 and “N1 and F1” for NF1. Then repeat this for items 2 . . . n.

Yet another option for creating a questionnaire is to use the items in the table above for Si, Se, Ne, Ni, Ti, Te, Fe, Fi to score the preference for the function attitudes and use mathematical equations like the ones above to determine the scores for the other elements of the personality.

Either or all of these approaches above together with the attitudinal scores (I,E) will lead to the subtype, e.g. INFP.

The system will also have pre-prepared template documents that can be quickly assembled by the software into the final individual profile, thus generating a comprehensive report to the individual that can be used by the individual for further study. The profile includes questions for self-reflection and offers the possibility of retaking one or more questionnaires to enhance the understanding of the individual.

The aforementioned pre-prepared template documents may include an introduction template document describing what is in the profile and how the individual can use it to better understand the elements that make up their personality. Then further pre-prepared template document documents will describe the four temperaments rating (Inventor-Visionary-Helper-Technician) of the individual as determined by the extensive analysis done by the preference calculator, as well as an in-depth description of the preferred temperament of the individual for further study. Another template document summarizes the principle subtype based on the analysis. And a final template document provides guidance for self-reflection on the results by asking a number of self-reflection questions.

The individual is then encouraged to follow-up with the self-reflection by possibly retaking the test with either the same questionnaire or possibly a new questionnaire. If the data that identifies preference for functions and attitude shows a large statistical variance, the individual is invited to re-submit preference data until a satisfactory result is achieved for the user.

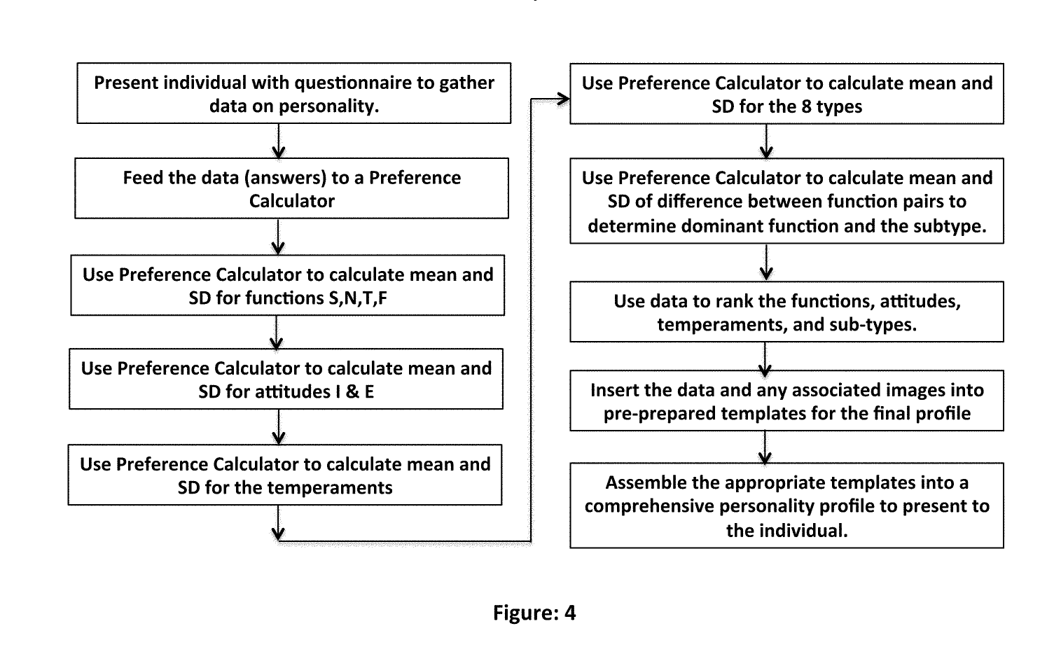

This method proceeds as shown in FIG. 4 as follows: presenting the individual with a plurality of questions and requesting the individual to select one of multiple responses to each question; feeding the responses into a software based preference calculator; using the preference calculator to calculate mean and standard deviations for each of the four functions sensing, intuition, thinking, and feeling; using the preference calculator to calculate mean and standard deviations for each of the two attitudes introversion and extroversion; using the preference calculator to calculate mean and standard deviations for each of the four temperaments Inventor, Visionary, Helper, and Technician; using the preference calculator to calculate mean and standard deviations for each of the eight types Operator, Investigator, Innovator, Architect, Caregiver, Host, Inspirer, and Visionary; using the preference calculator to calculate the mean and standard deviation of the differences between function pairs to determine the dominant function and the subtype; using the results from the preference calculator to rank the functions, attitudes, temperaments, and subtypes; inserting the rankings results and images associated with those results into pre-prepared template documents; assembling these template documents into a comprehensive personality profile to present to the individual; wherein the individual can then reflect upon their profile and decide if it is a good fit, or decide to re-take the questionnaire n times during any period of time until a good fit is experienced.

The method can be implemented by a computing system for analyzing personality types for an individual comprising: a first computer readable code for presenting the individual with a plurality of questions and requesting the individual to select one of multiple responses to each question; a second computer readable code for feeding the responses into a software based preference calculator that acts on the responses to calculate the mean and standard deviations for each of four functions sensing, intuition, thinking, and feeling; for each of two attitudes introversion and extroversion; for each of four temperaments Inventor, Visionary, Helper, and Technician, for each of eight types Operator, Investigator, Innovator, Architect, Caregiver, Host, Inspirer, and Visionary; and further to calculate the mean and standard deviation of the difference between function pairs T-F and S-N to determine the dominant function and the subtype; a third computer readable code for using the data from the preference calculator to rank all of the functions, attitudes, temperaments, types, and subtypes; a fourth computer readable code for inserting rankings results and images associated with those results into pre-prepared template documents, and then assembling these template documents into a comprehensive personality profile to present to the individual.

The computing system disclosed herein can be applied by use of an online system or a smartphone or tablet app that effectively aids anyone who has an interest in this to analyze their own personality at a lower cost than other solutions.

The methodology can also be used to analyze and understand relationships, team roles, leadership styles and any other area of life where the strengths and limitations of the different personality types play an important role (like profession, marriage, sports, hobbies).

While the present disclosure has been described above in terms of specific embodiments, it is to be understood that the disclosure is not limited to these disclosed embodiments. Many modifications and other embodiments of the disclosure will come to mind of those skilled in the art to which this disclosure pertains, and which are intended to be and are covered by both this disclosure and the appended claims. It is indeed intended that the scope of the disclosure should be determined by proper interpretation and construction of the appended claims and their legal equivalents, as understood by those of skill in the art relying upon the disclosure in this specification and the attached drawings.

1. A method for analyzing personality type for an individual comprising:
a. presenting the individual with a plurality of questions and requesting the individual to select one of multiple responses to each question;
b. feeding the responses into a software based preference calculator;
c. using the preference calculator to calculate mean and standard deviations for each of the four functions sensing, intuition, thinking, and feeling;
d. using the preference calculator to calculate mean and standard deviations for each of the two attitudes introversion and extroversion;
e. using the preference calculator to calculate mean and standard deviations for each of the four temperaments Inventor, Visionary, Helper, and Technician;
f. using the preference calculator to calculate mean and standard deviations for each of the eight types Operator, Investigator, Innovator, Architect, Caregiver, Host, Inspirer, and Visionary;
g. using the preference calculator to calculate mean and standard deviations of the differences between function pairs to determine a dominant function and the subtype (INTJ, INFJ, INTP, ISTP, ISTJ, ISFJ, INFP, ISFP, ENTP, ENFP, ENTJ, ESTJ, ESTP, ESFP, ENFJ, or ESFJ);
h. using the results from the preference calculator to rank the functions, attitudes, temperaments, types, and subtypes;
i. inserting the rankings results and images associated with those results into pre-prepared template documents;
j. assembling these template documents into a comprehensive personality profile to present to the individual;
k. wherein the individual can then reflect upon their profile and decide if it is a good fit, or decide to re-take the questionnaire n times during any period of time until a good fit is experienced.

2. The method for analyzing personality type for an individual of claim 1 wherein the step of assembling template documents into a comprehensive personality profile further comprises utilizing a pre-prepared introduction template document and a prepared self-reflection document added to the personality profile.

3. A computing system for analyzing personality types for an individual comprising:
a. a first computer readable code for presenting the individual with a plurality of questions and requesting the individual to select one of multiple responses to each question;
b. a second computer readable code for feeding the responses into a software based preference calculator that acts on the responses to calculate the mean and standard deviations for each of four functions sensing, intuition, thinking, and feeling; for each of two attitudes introversion and extroversion; for each of four temperaments Inventor, Visionary, Helper, and Technician, for each of eight types Operator, Investigator, Innovator, Architect, Caregiver, Host, Inspirer, and Visionary; and further to calculate the mean and standard deviation of the difference between function pairs T-F and S-N to determine the dominant function and a subtype (INTJ, INFJ, INTP, ISTP, ISTJ, ISFJ, INFP, ISFP, ENTP, ENFP, ENTJ, ESTJ, ESTP, ESFP, ENFJ, or ESFJ);
c. a third computer readable code for using the data from the preference calculator to rank all of the functions, attitudes, temperaments, types, and subtypes;
d. a fourth computer readable code for inserting rankings results and images associated with those results into pre-prepared template documents, and then assembling these template documents into a comprehensive personality profile to present to the individual.

4. The computing system for analyzing personality types of claim 3 wherein the software readable codes are applied in a smartphone app.

5. The computing system for analyzing personality types of claim 3 wherein the software readable codes are applied in a tablet computing device.
